(19) United States
(12) Patent Application Publication
(10) Pub. No.: US 2002/0071756 A1
(43) Pub. Date: Jun. 13, 2002

(54) Dual wafer edge gripping end effector and method therefor

(76) Inventor: Jose R. Gonzalez, Phoenix, AZ (US)

Correspondence Address: James L. Farmer, Esq., SpeedFam-IPEC Corporation, 305 North 54th Street, Chandler, AZ, 85226, US

(21) Appl. No.: 09/736,487

(22) Filed: Dec. 13, 2000

(51) Int. Cl. B65G 49/07

(52) U.S. Cl. 414/941; 294/103.1

(57) ABSTRACT

An end effector having a paddle adapted for mounting to a robot arm. On the top side of paddle are two finger housings spaced apart and in opposed relationship. In the preferred embodiment, one of these finger housings is slideable along the paddle while the other is fixed. Mounted to the outer surfaces of these finger housings are finger assemblies for gripping a wafer on its edge and configured to assist in the transfer of the wafer from the end effector to some other device. Finger housings with finger assemblies can also be mounted to the bottom surface of the paddle, allowing the end effector to carry two wafers at one time. Methods for handling and transferring wafers using these end effectors are also disclosed.

### TECHNICAL FIELD

The present invention relates to the transfer of articles, such as semiconductor wafers, and more particularly to an end effector that grips a wafer on its edge and a method for handling and transferring very thin semiconductor wafers.

### BACKGROUND OF THE INVENTION

The use of robot arms is a well established manufacturing expedient in applications where human handling is inefficient and/or undesired. For example, in the semiconductor arts robot arms are used to handle wafers during various process steps. Such process steps include chemical-mechanical planarization (CMP), etching, deposition, passivation, etc., where a sealed environment must be maintained to limit the likelihood of contamination and to ensure that various specific processing conditions are provided.

Current practice includes the use of an end effector (also known as a robot blade) attached to robot arms to load semiconductor wafers from a loading port into various processing ports within a multiple chamber process system. The robot arms are then employed to retrieve the wafer from a particular port after processing within an associated process chamber. The wafer is then shuttled by the robot arms to the next port for additional processing. When all processing within the system is complete, the robot arm returns the semiconductor wafer to the loading port and the next wafer is placed into the system by the robot arm for processing. Typically, a stack of several semiconductor wafers is handled in this manner during each process run.

Typical wafer handlers hold the wafer on its bottom side using backside suction generated by the wafer handler. Alternatively, some wafer processing machines use a suction from the device receiving the wafer to pull the wafer from the wafer handler. However, the application of a mechanical apparatus and action to the top or device side of the wafer may damage or contaminate the wafer.

Accordingly there is a need for an end effector that is capable of gripping a silicon wafer on its edge and a method for handling and transferring very thin semiconductor wafers. Additionally there is a need for an end effector that can grip more than one wafer at a time.

### SUMMARY OF THE INVENTION

An object of the present invention is to provide an end effector that is capable of gripping a silicon wafer on its edge.

Another object of the present invention is to provide an end effector that is capable of carrying multiple wafers at one time.

Yet another object of the present invention is to provide a method for handling and transferring very thin semiconductor wafers.

The present invention meets these objectives by providing an end effector having a paddle adapted for mounting to a robot arm. On the top side of the paddle are two finger housings spaced apart and in opposed relationship. In the preferred embodiment, one of these finger housings is slideable along the paddle while the other is fixed. Mounted to the outer surfaces of these finger housings are finger assemblies for gripping a wafer on its edge. The finger assemblies are also configured to assist in the transfer of the wafer from the end effector to some other device. Finger housings and finger assemblies can also be mounted on the bottom side of the paddle enabling the end effector to carry two wafers at one time.

In operation, once the wafer is mounted to the end effector contemplated by the present invention, the robot brings the end effector to the device to which the wafer is to be transferred. The wafer is brought within the influence of suction generated in the device. The device then engages the finger assemblies so that the end effector's grip is released. Concurrently, the finger assemblies gently push the wafer towards device enabling the suction force to pull the wafer to the device. The end effector can then be rotated 180 degrees and this process is then repeated for a wafer is mounted on the bottom side.

By gripping the wafer on the edge damage to the top and bottom of the surfaces is avoided. Further, the twist effect of the finger assemblies that assists in transferring the wafer to the device reduces the magnitude of the required suction, thus avoiding further damage to the wafer.

These and other objects, features and advantages of the present invention are specifically set forth in or will become apparent from the following detailed description of a preferred embodiment of the invention when read in conjunction with the accompanying drawings.

### BRIEF DESCRIPTION OF THE DRAWINGS

FIG. 1 is a top perspective view of the end effector contemplated by the present invention.

FIG. 2 is an overall perspective view of an alternative embodiment of the end effector contemplated by the present invention.

FIG. 3 is a partial cross-sectional view taken along line 3-3 of FIG. 1.

FIG. 4 is a perspective view of the end effector of claim 1 with a wafer mounted on it.

### DESCRIPTION OF THE PREFERRED EMBODIMENT

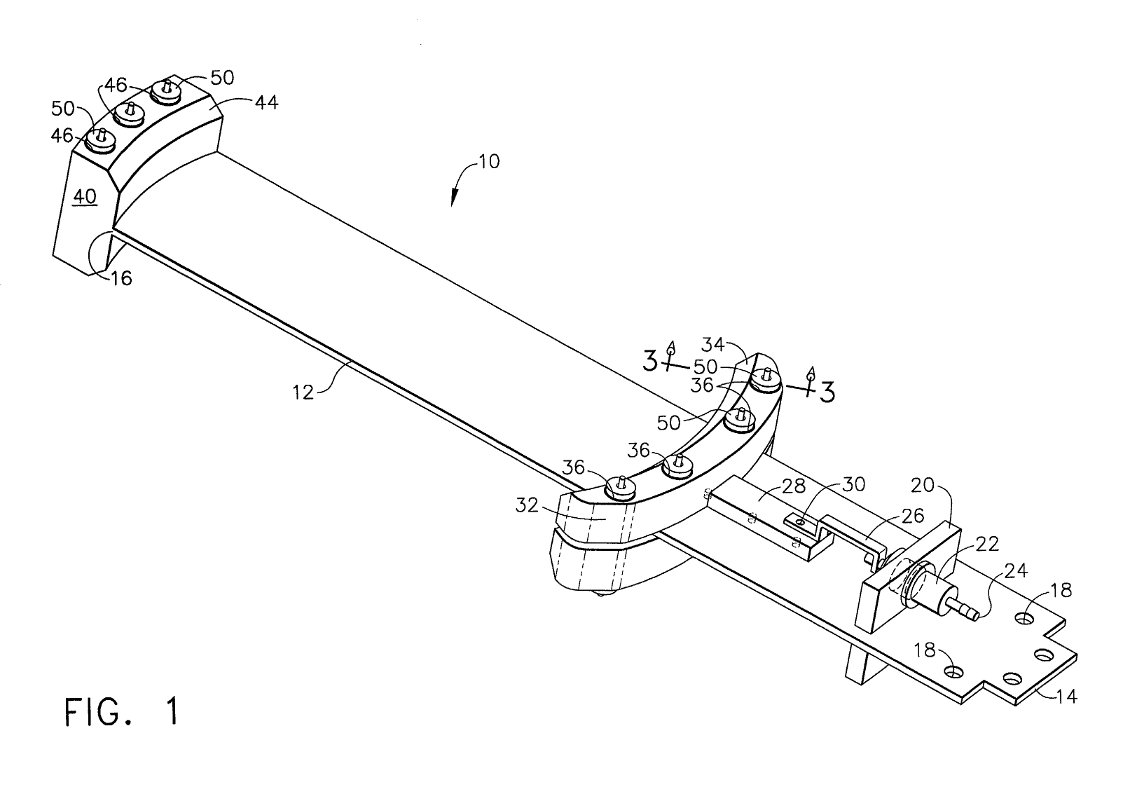

Referring to FIG. 1, an edge gripping end effector is generally denoted by reference numeral 10. The bottom and top of the end effector 10 are structurally and functionally identical allowing the end effector 10 to hold two wafers at one time. One wafer on its top side and one wafer on its bottom side. For purposes of clarity the following describes the top side of the end effector 10 but the description also applies to the bottom side.

The end effector 10 includes a flat plate 12 also referred to as a paddle that extends from a first end 14 to a second end 16. The thickness of the paddle 10 is on the order of 6 to 12 mm. The first end 14 has a plurality of holes 18 that are used, in a manner familiar to those skilled in the art, to couple the end effector 10 to a robot arm, (not shown). Moving from the first end 14 to the second end 16, mounted on the paddle 12 is an actuator support 20 to which is mounted a commercially available pneumatic actuator 22. The actuator 22 receives air from a source not shown through port 24. In response to pressurized air flowing through port 24, the actuator 22 causes a connector 26 to extend (i.e. move forward toward end 16) or retract (i.e. move backward toward end 14). The connector 26 is coupled to one end of a slider or linear bearing 28 by a pin or screw 30. The slider or linear bearing 28 rests on the surface of the paddle 12 and at its second end is connected to a slideable finger housing 32. The linear bearing 28 is a commercially available bearing having a fixed portion connected by screws to the paddle and slideable portion mounted to the fixed portion which is coupled to the finger housing 32.

The slideable finger housing 32 generally has an arcuate shape that matches the shape of the outer edge of the wafer and also has an inward facing sloped or tapered surface 34. The housing 32 also has at least one threaded hole 36 for receiving a finger assembly 50 which will be described in detail later in this application. In the preferred embodiment, there are four threaded holes 36 equally spaced along the top surface of the slideable finger housing 32. It should be appreciated that the number of threaded holes 36 and their spacing may vary with different embodiments of the present invention.

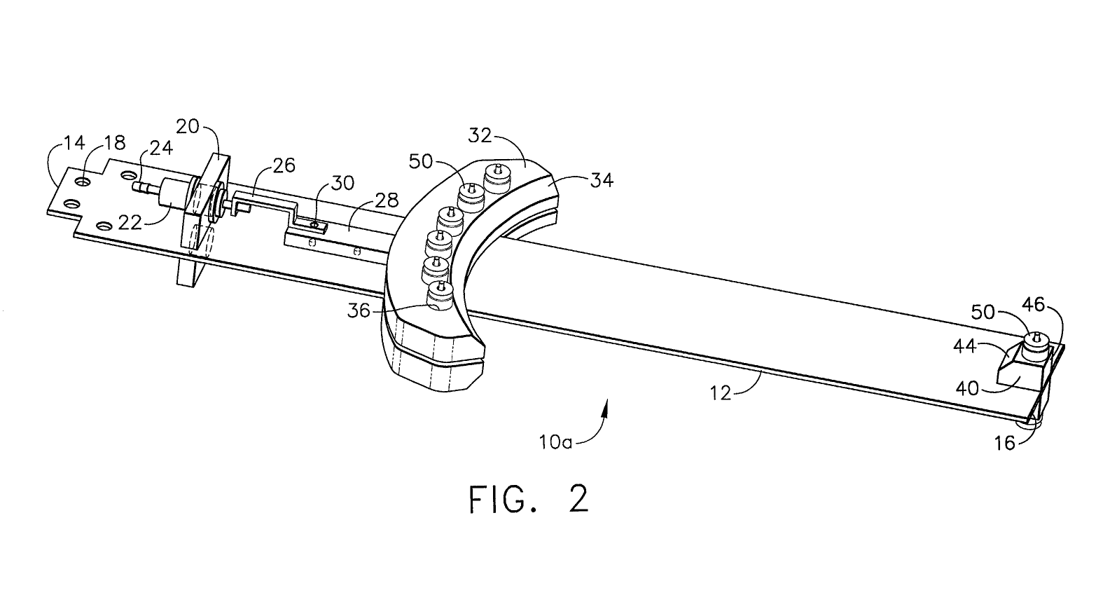

A fixed finger housing 40 is connected to the end 16 of the paddle 12. This assembly 40 does not move. Like the slideable finger housing 32, the fixed finger housing 40 has an arcuate shape that matches the shape of the outer edge of the wafer and also has an inward facing arcuate sloped or tapered surface 44 that is opposed relation to surface 34. In the preferred embodiment, the housing 40 has three threaded holes 46 for receiving in each hole a finger assembly 50 which will be described in detail later in this application. It should again be appreciated that the number of threaded holes 46 and their spacing may vary with different embodiments of the present invention. FIG. 2 shows the bottom side of an alternative embodiment 10a where the only difference is the number of holes 36, 46. In this embodiment, the slideable finger housing 32 has six threaded holes 36 and fixed finger housing 40 has a single threaded hole 46. It should further be appreciated that the number of holes on the slideable finger housing may be less than the number of holes on the fixed finger housing.

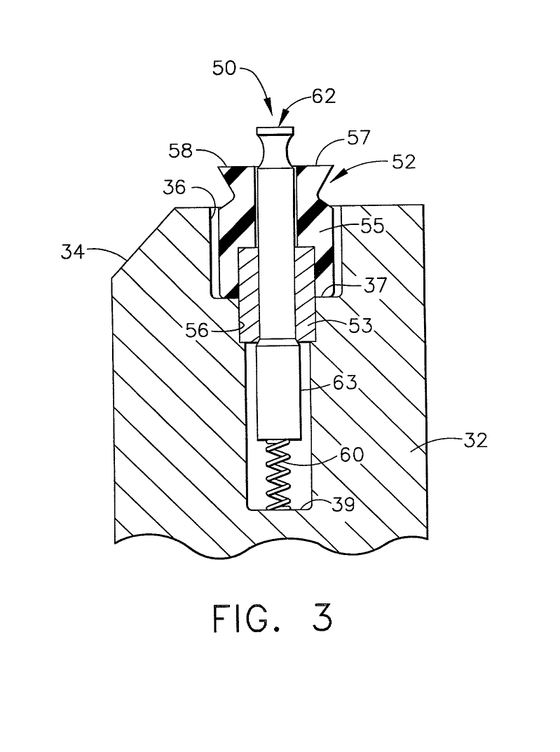

Referring to FIG. 3, the threaded hole 36 has two tiers. A first tier 37 at a first depth from the surface and a second tier 39 extending further inward from the first tier and centered relative to the first tier. The threaded holes 46 are identical to the hole 36. Disposed within the hole 36 is the finger assembly 50. The finger assembly 50 is comprised of a bellows cup 52 having an annular fitting 53 and a annular resilient member 55. The bottom of the resilient member 55 rests on the first tier 37 and the top extends outward and beyond the hole 36. The fitting 53 has a threaded outer surface portion that engages the threads 56 disposed on the surface of the hole 36 just below the tier 37. Above the tier 37, the fitting 53 is not threaded and extends into a counterbore in the resilient member 55. The resilient member 55 is preferably made of a resilient rubber like material such as Urethane, Nitrile, Silicone, Flourocarbon, and Neoprene and is press fit onto the fitting 53. Disposed through the bellows cup 52 is a rod or pin 62. The base portion 63 of the pin 62 has a diameter that is greater than the diameter of the fitting 53 and the remainder of the pin 62. A spring 60 is mounted between the bottom of the base portion 63 and the second tier 39 of the hole 36.

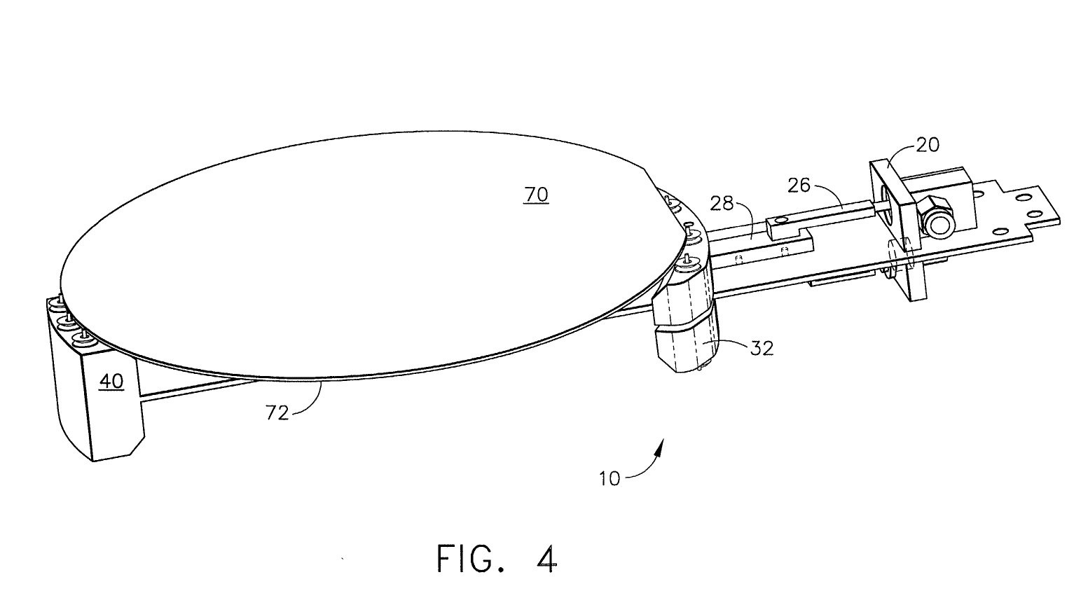

Referring to FIG. 4, in operation the end effector 10 is initially positioned with the slideable finger housing 32 retracted and the surfaces 34, 44 spaced apart so that a standard size wafer 70 will rest on the surfaces 34, 44. The slideable finger assembly 32 is then extended towards the fixed finger assembly 40. This movement of the slideable finger assembly 32 pushes the wafer 70 outward along the surfaces 34, 44 until the wafer 70 rests on the top surface of the inner portions 56 with its edge 72 embraced against the rods or pins 62. The rods or pins 62 exert a compressive force on the edge 72 of the wafer 70 so as to hold it in place even when the end effector 10 is rotated 180 degrees from the top position.

When the wafer 70 needs to be transferred, for example, to a polishing pad, this is usually accomplished by a slight suction on the pad side which pulls the wafer 70. The wafer 70 must be in the up position. To avoid damaging the wafer 70, the suction is as weak as permissible while still being able to pull the wafer. The subject invention assists in this transfer in the following manner and thereby reduces the magnitude of the required suction. As the wafer 70 is brought near the pad, the structure holding the pad will push down on the rods or pins 62 causing them to retract and compress the spring 60. Once the rods have retracted into their respective bellows cup 52, they no longer engage the wafer 70. Concurrently, with the retraction of the rods or pins 62, the pad structure will contact the outer portions 57 of the bellows cups 52, (see FIG. 3). This contact pushes the outer portions 57 inward. Due to its resilience and shape, the bellows cups 52 twist causing their inner portions 58 to move outward imparting to the wafer 70 a slight push in the direction of the polishing pad. This slight push frees the wafer 70 from the end effector 10 and with the suction from the pad, the polishing pad can grab hold of the wafer. The end effector 10 is then moved away from the pad, and the springs 60 push the rods or pins 62 back to their original positions.

Upon completion of the polishing process the wafer 70 is returned to the end effector 10 as follows. The up side of the effector is brought to the polishing pad and has the slideable finger assembly 32 fully retracted. The wafer 70 is then released onto the surfaces 34, 44. The slideable finger assembly 32 is then extended until the wafer 70 rests on the top surface of the inner portions 58 and is held by the rods or pins 62. If a wafer is being held on the bottom side of the paddle, the end effector 10 can be rotated 180 degrees and the above mentioned processes repeated.

By being able to carrying two wafers, the end effector 10 is more efficient that single wafer systems. Further, as the end effector 10 grips wafers on their edges, damage to the top and bottom surfaces of the wafers is avoided. Further, the twist effect of head portions assists in transferring the wafers to the device reducing the magnitude of the required suction, thus avoiding further damage to the wafers.

Although the invention has been described in terms of a polishing pad process, it will be appreciated by those skilled in the art that the invention can be used in all sorts of other wafer processing steps. Accordingly, various changes and modifications may be made to the illustrative embodiment without departing from the spirit or scope of the invention. It is intended that the scope of the invention not be limited in any way to the illustrative embodiment shown and described but that the invention be limited only by the claims appended hereto.

What is claimed is:

1. An end effector comprising:
paddle extending from a first end to a second end, the first end adapted for mounting to a robot arm and having a top side and a bottom side;
first and second assembly mounted on one of said top and bottom sides and spaced apart in opposed relationship, each of said first and second assemblies having at least one opening extending inwards from a top surface;
a finger assembly disposed in one of said openings.

2. The end effector of claim 1 wherein said finger assembly includes a rod moveable from a first position where a portion of said rod extends outward beyond the finger assembly to a second position where said rod is retracted within the finger assembly.

3. The end effector of claim 2 wherein said opening has a first tier and a second tier extending inward from said first tier and centered relative to said first tier.

4. The end effector of claim 3 wherein said rod has a base portion having a diameter greater than the diameter of the remainder of the rod.

5. The end effector of claim 4 further comprising a spring disposed between said base portion of said rod and said second tier.

6. The end effector of claim 1 wherein said finger assembly includes an annular bellows cup.

7. The end effector of claim 6 wherein said bellows cup comprises a fitting and a resilient member, with the bottom surface of the resilient member resting on the first tier and the top of the resilient member extending outward from said opening.

8. The end effector of claim 7 wherein said fitting has a threaded outer surface portion that engages threads disposed in said opening just below the first tier.

9. The end effector of claim 8 wherein said resilient member is made of a resilient rubber.

10. The end effector of claim 9 wherein said resilient rubber is selected from the group consisting of Urethane, Nitrile, Silicone, Flourocarbon, and Neoprene.

11. The end effector of claim 1 wherein the number of openings in said first assembly is different than the number of openings in said second assembly.

12. The end effector of claim 1 wherein said first assembly has a first sloped surface and said second assembly has a second sloped surface, said first and second sloped surfaces being in opposed relationship.

13. The end effector of claim 10 wherein said first and second sloped surfaces are also arcuate.

14. The end effector of claim 1 wherein said first assembly is moveable along said paddle and said second assembly is fixed.

15. The end effector of claim 12 further comprising an actuator mounted to said paddle and a slider mounted to said paddle for coupling said actuator to said moveable assembly.

16. The end effector of claim 13 wherein said actuator is a pneumatic actuator.

17. The end effector of claim 1 wherein said first and second assemblies are moveable along said paddle.

18. A dual wafer end effector comprising:
a paddle extending from a first end to a second end, the first end adapted for mounting to a robot arm and having a top side and a bottom side;
a first and second assembly mounted on said top side and spaced apart in opposed relationship;
a third and fourth assembly mounted on said bottom side and spaced apart in opposed relationship, each of said first, second, third and fourth assemblies having at least one opening extending inwards from its respective top surface;
a plurality of resilient members, each resilient member having disposed in one of said openings and having a head portion extending outward from said opening.

19. The end effector of claim 18 wherein each of said resilient members is annular and a rod is disposed through each of said resilient members, said rod being moveable from a first position where a portion of said rod extends outward beyond said head portion to a second position where said rod is retracted within said resilient member.

20. The end effector of claim 19 wherein each of said openings has a first tier and a second tier extending inward from said first tier and centered relative to said first tier.

21. The end effector of claim 20 further comprising a spring disposed within each of said openings, each spring having a first end in contact with one of said second tiers and having a second end in contact with an end of one of said rods.

22. The end effector of claim 18 wherein each of said resilient members is a bellows cup.

23. The end effector of claim 1 wherein said first assembly has a first sloped surface and said second assembly has a second sloped surface, said first and second sloped surfaces are in opposed relationship and said third assembly has a third sloped surface and said fourth assembly has a fourth sloped surface, said third and fourth sloped surfaces being in opposed relationship.

24. The end effector of claim 23 wherein said first, second, third, and fourth sloped surfaces are arcuate.

25. The end effector of claim 18 wherein said first and third assemblies are moveable along said paddle and said second and fourth assemblies are fixed.

26. The end effector of claim 25 further comprising a first actuator mounted to said top side of said paddle and a first slider mounted to said top side of said paddle for coupling said first actuator to said first assembly and a second actuator mounted to said bottom side of said paddle and a second slider mounted to said bottom side of said paddle for coupling said second actuator to said third assembly.

27. The end effector of claim 26 wherein said first and second actuators are pneumatic actuators.

28. The end effector of claim 18 wherein said first, second, third, and fourth assemblies are moveable along said paddle.

29. An end effector comprising:
a paddle extending from a first end to a second end, the first end adapted for mounting to a robot arm;
a fixed assembly mounted to said paddle and having a first sloped surface;
a moveable assembly mounted to said paddle, said moveable assembly moveable between an extended position, where it is closest to said fixed assembly, and a retracted position, where it is farthest from said fixed assembly, said moveable assembly having a second sloped surface in opposed relationship to said first sloped surface; and
a first finger assembly mounted to said fixed assembly and a second finger assembly mounted to said moveable assembly, each of said finger assemblies comprising an annular bellows shaped resilient member having an inner and outer portion and a spring mounted rod disposed within said resilient member and extending outward from said resilient member when said spring is not in compression.

30. A method for transferring a wafer to a device producing a suction using the end effector of claim 30 comprising the steps of:
a) with said moveable assembly in said retracted position, mounting said wafer onto said sloped surfaces;
b) extending said moveable assembly so that the wafer slides over the sloped surface until it rests on the inner portions of said resilient members and the edge of the wafer is held by said rods;
c) bringing said wafer to said device so that a surface of said device contacts the rods;
d) bringing the wafer within the influence of said suction by pushing inward on the rods and causing them to retract into the resilient member and then pushing inward on the outer portions of the resilient member causing the inner portions of the resilient members to push the wafer away from the effector and to the device.

31. A dual wafer end effector comprising:
a paddle extending from a first end to a second end, the first end adapted for mounting to a robot arm, said paddle having a top and bottom side;
a first fixed assembly mounted to said top side and having a first sloped surface, a first moveable assembly mounted to said top side, said first moveable assembly moveable between an extended position, where it is closest to said first fixed assembly, and a retracted position, where it is farthest from said first fixed assembly, said first moveable assembly having a second slope surface in opposed relationship to said first sloped surface;
a first finger assembly mounted to said first fixed assembly and a second finger assembly mounted to said first moveable assembly, a second fixed assembly mounted to said bottom side and having a third first sloped surface;
a second moveable assembly mounted to said bottom side, said second moveable assembly moveable between an extended position, where it is closest to said second fixed assembly, and a retracted position, where it is farthest from said second fixed assembly, said second moveable assembly having a fourth sloped surface in opposed relationship to said third sloped surface;
a third finger assembly mounted to said second fixed assembly and a fourth finger assembly mounted to said second moveable assembly;
each of said finger assemblies comprising an annular bellows shaped resilient member having an inner and outer portion and a spring mounted rod disposed within said resilient member and extending outward from said resilient member when said spring is not in compression.

32. A method for transferring two wafers to one or more devices that produce a suction using the dual wafer effector of claim 31 comprising the steps of:
a) with said first moveable assembly in said retracted position, mounting a first wafer onto said first and second sloped surfaces;
b) extending said first moveable assembly so that said first wafer slides over the first and second sloped surfaces until it rests on the inner portions of said first and second resilient members and the edge of the first wafer is held by said first and second rods;
c) rotating said effector 360 degrees;
d) with said second moveable assembly in said retracted position, mounting a second wafer onto said third and fourth sloped surfaces;
e) extending said second moveable assembly so that said second wafer slides over the third and fourth sloped surfaces until it rests on the inner portions of said third and fourth resilient members and the edge of the second wafer is held by said third and fourth rods;
f) bringing said first wafer to said first device so that a surface of said first device contacts the first and second rods;
g) bringing the first wafer within the influence of said suction of said first device by pushing inward on the first and second rods causing them to retract into the first and second resilient members and then pushing inward on the outer portions of the first and second resilient members causing the inner portions of the first and second resilient members to push the first wafer away from the effector and to the first device;
h) bringing said second wafer to said second device so that a surface of said second device contacts said third and fourth rods;
i) bringing the second wafer within the influence of said suction of said second device by pushing inward on the third and fourth rods causing them to retract into the third and fourth resilient members and then pushing inward on the outer portions of the third and fourth resilient members causing the inner portions of the third and fourth resilient members to push the second wafer away from the effector and to the second device.
